(19) United States
(12) Patent Application Publication
(10) Pub. No.: US 2015/0069738 A1
(43) Pub. Date: Mar. 12, 2015

(54) EXERCISE STROLLER

(71) Applicants: Tiffany Knight, Gilbert, AZ (US); Mario Esquer, Scottsdale, AZ (US)

(72) Inventors: Tiffany Knight, Gilbert, AZ (US); Mario Esquer, Scottsdale, AZ (US)

(21) Appl. No.: 14/025,736

(22) Filed: Sep. 12, 2013

(51) Int. Cl. B62B 9/20

(52) U.S. Cl. CPC B62B 9/206
USPC 280/650; 280/47.38

(57) ABSTRACT

The present invention relates to an exercise stroller. The handles of the stroller are pivotally attached to the stroller frame and can be moved in an alternating forward and backward direction. Each of the stroller handles includes a tension device, such as, for example, elastic members, a hydraulic cylinder, various types of springs, etc., to provide resistance to the movement of the handles. In an embodiment, each handle includes a pair of torsion springs, wherein one of the torsion springs is left wound and the other of the pair of torsion springs is right wound. In this configuration, each pair of torsion springs is enclosed in a plastic housing, one of the torsion springs disposed on a left side and the other torsion spring disposed on a right side, wherein a fastener extends through central portions of the spring and secures the pair of the torsion springs to the handle.

### BACKGROUND OF THE INVENTION

1. Field of the Invention

The present invention relates to a stroller, and, more particularly, to an exercise stroller having a pair of moveable arms allowing the user to perform a rigorous workout while pushing the stroller.

2. Description of the Related Art

Pregnancy results in many physical changes to the body usually including substantial weight gain. During pregnancy, such weight gain is generally considered beneficial, and doctors recommend an expectant mother to add 25 to 35 pounds. However, many women keep some of the extra weight after giving birth, and getting back to pre-pregnancy weight often requires considerable effort.

It has been shown that diet and exercise together are the most effective way for a new mother to lose weight. Dieting can be done by careful selection of food and reduction of portion size. However, exercise is often difficult to incorporate into the lives of busy mothers with babies, and without sufficient exercise, dieting by itself may be insufficient.

In recent years, it has become common to see mothers jog while pushing strollers. A new type of stroller, sometimes called a ‘jogging stroller’, has been marketed to facilitate this type of exercise. Jogging strollers typically have three relatively large wheels, a suspension assembly that allows the stroller to smoothly traverse bumpy ground, and extra padding and safety features to protect the child passenger. Although such jogging strollers are useful for exercise, they do not allow much upper body conditioning since arms are not used except to push the stroller forward.

### SUMMARY OF THE INVENTION

The present invention relates to an exercise stroller. The handles of the stroller are pivotally attached to the stroller frame and can be moved in an alternating forward and backward direction. Each of the stroller handles includes a tension device, such as, for example, elastic members, a hydraulic cylinder, various types of springs, etc., to provide resistance to the movement of the handles. In an embodiment, each handle includes a pair of torsion springs, wherein one of the torsion springs is left wound and the other of the pair of torsion springs is right wound. In this configuration, each pair of torsion springs is enclosed in a plastic housing, one of the torsion springs disposed on a left side and the other torsion spring disposed on a right side, wherein a fastener extends through central portions of the spring and secures the pair of the torsion springs to the handle.

In various embodiments, the exercise stroller may further include numerous other features for comfort, safety, and convenience. For example, the seats may be well cushioned to absorb sudden bumps, the legs and/or frame may include shock absorbers, seat belts may be provided, and the stroller frame may be foldable. Additionally, a cover can be attached to the stroller frame capable of providing shading for a child sitting in the stroller.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 illustrates an exercise stroller, according to an embodiment of the present invention;

FIG. 2 illustrates a side view of the exercise stroller of FIG. 1;

FIG. 3 is close-up side view of a top portion of the exercise stroller showing forward/backward movements of the handles;

FIG. 4 illustrates the exercise stroller in a folded position;

FIG. 5 illustrates an exploded view of a tension device for a handle of the exercise stroller, according to an embodiment of the present invention;

FIGS. 6A-6C illustrate various views of the tension device of FIG. 5 along with parts of the handle; and

FIG. 7 illustrates a perspective view of a handle of the exercise stroller incorporating the tension device fully assembled.

### DETAILED DESCRIPTION OF THE INVENTION

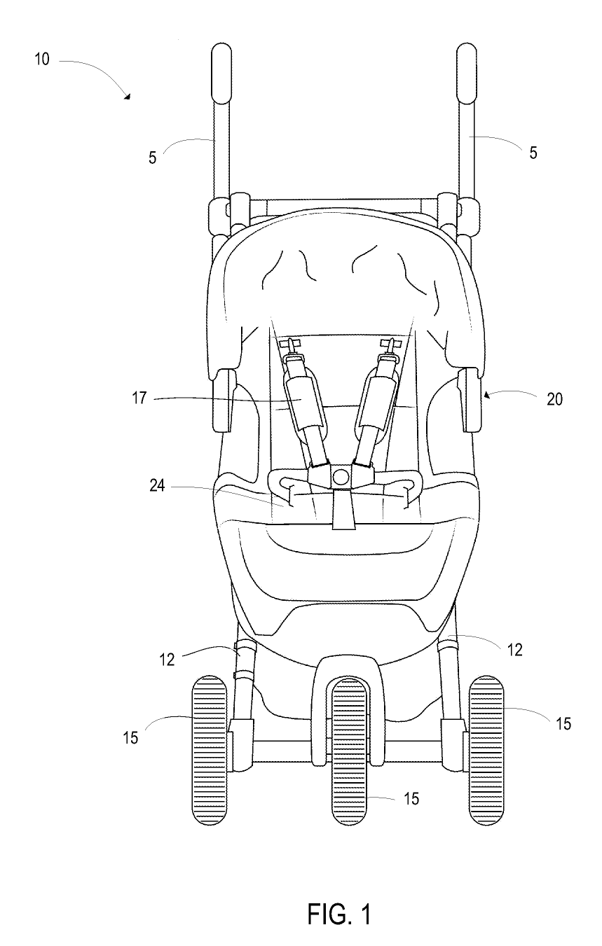

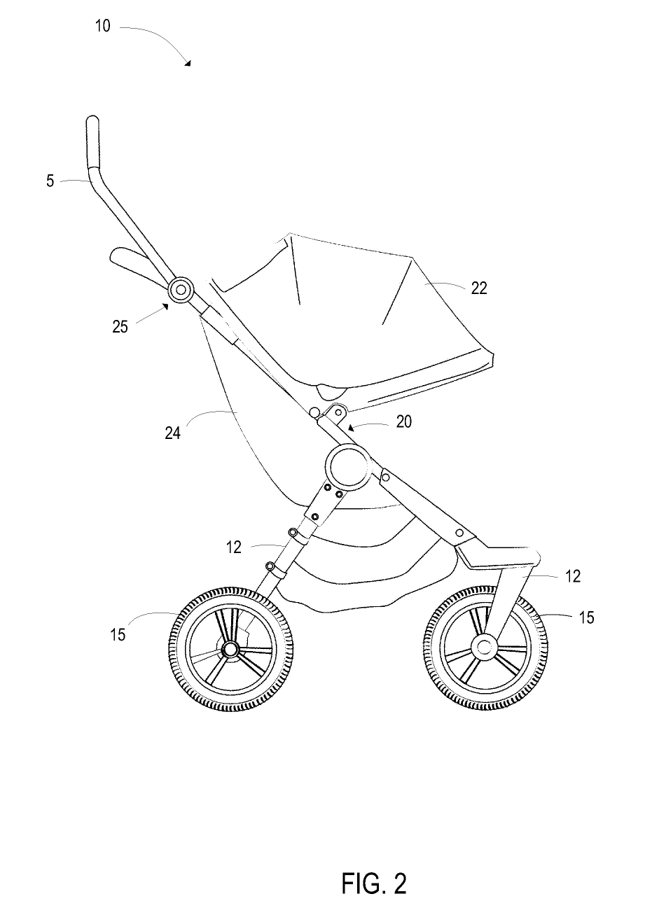

FIG. 1 shows an exercise stroller 10 according to an embodiment of the present invention. FIG. 2 illustrates a side view of the exercise stroller 10. As shown, the exercise stroller 10 includes a stroller frame 20, a seat 24 suspended from the stroller frame 10, at least three wheels 15, each attached to the stroller frame 20 by a respective leg 12, and a pair of handles 5, each handle 5 pivotally attached to the stroller frame 20.

The stroller frame can be a tubular frame made from steel or aluminum, for example, capable of safely supporting a child weighing at least 50 pounds. The seat 24 can be made of a fabric material having folded-over edges to accommodate entry of tubular portions of the stroller frame 24. For safety, the exercise stroller 10 can have a seat/shoulder belt 17. The wheels 15 can be swivel of fixed, and the size chosen will depend on such considerations as maneuverability and ease of storage. Typical sizes of the wheels 15 are from about 8 inches to 20 inches in diameter. In various embodiments, the exercise stroller may further include numerous other features for comfort, safety, and convenience. For example, the seat 24 may include extra cushioning to absorb sudden bumps and the legs 12 and/or frame 20 may include shock absorbers. Additionally, a cover 22 may be attached to the stroller frame 20 capable of providing shading for a child sitting in the stroller 10.

As will be described in greater detail, to provide the user (i.e., the person pushing the exercise stroller 10) with a rigorous resistance exercise, each of the handles 5 further includes a tension device 25. In a preferred embodiment, each of the tension devices 25 includes a pair of torsion springs. However, it is to be understood that the tension device could instead include elastic members, a hydraulic cylinder, various types of other springs, etc., to provide resistance to the movement of the handles in both the backward and forward directions.

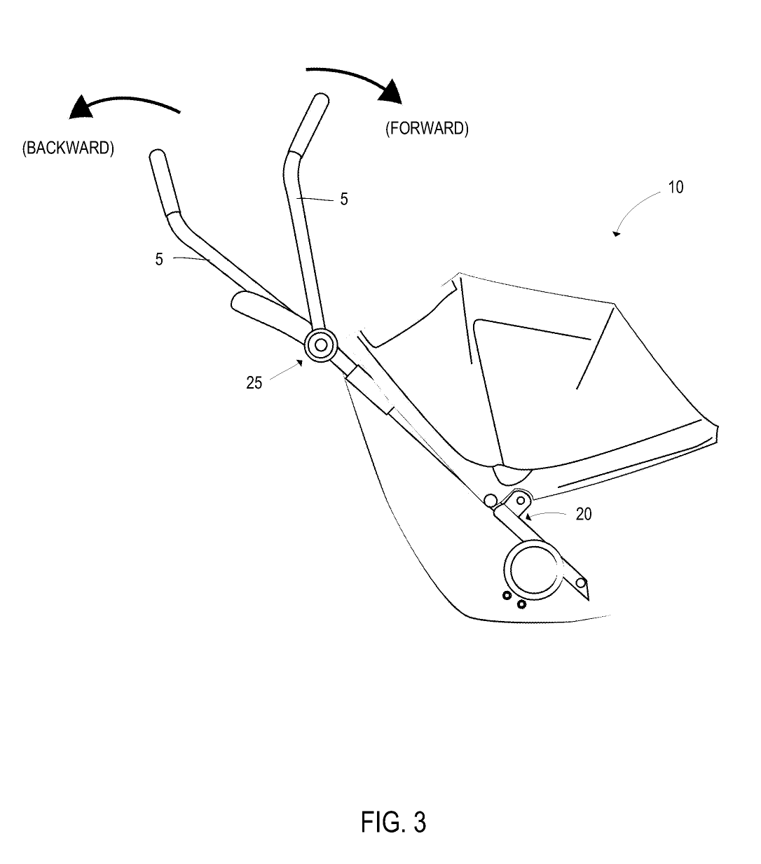

FIG. 3 shows a close-up side view of a top portion of the exercise stroller 10 showing the forward/backward alternating movements. As illustrated, the user can push one of the handles 5 in a forward direction while the other handle 5 is pulled in a backward direction. Thus, the exercise stroller 10 can provide an aerobic workout while being pushed.

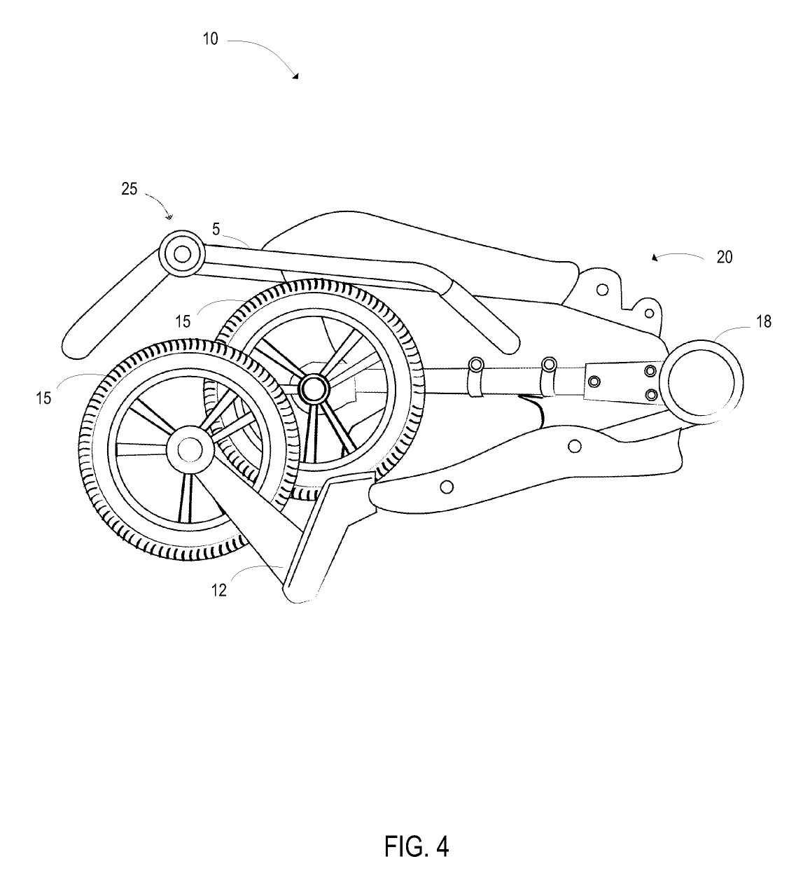

FIG. 4 illustrates the exercise stroller 10 in a folded position. As illustrated, the frame 20 includes a frame pivot 18 allowing the frame 20 to assume the folded position when opposing portions of the frame 20 are moved as shown. It is to be understood that the exercise stroller 10 may further include a latch or other mechanism to enable the folding as well as a lock to keep the device in the folded position. It is to be understood that the notion of a folded stroller is well known to those skilled in the art.

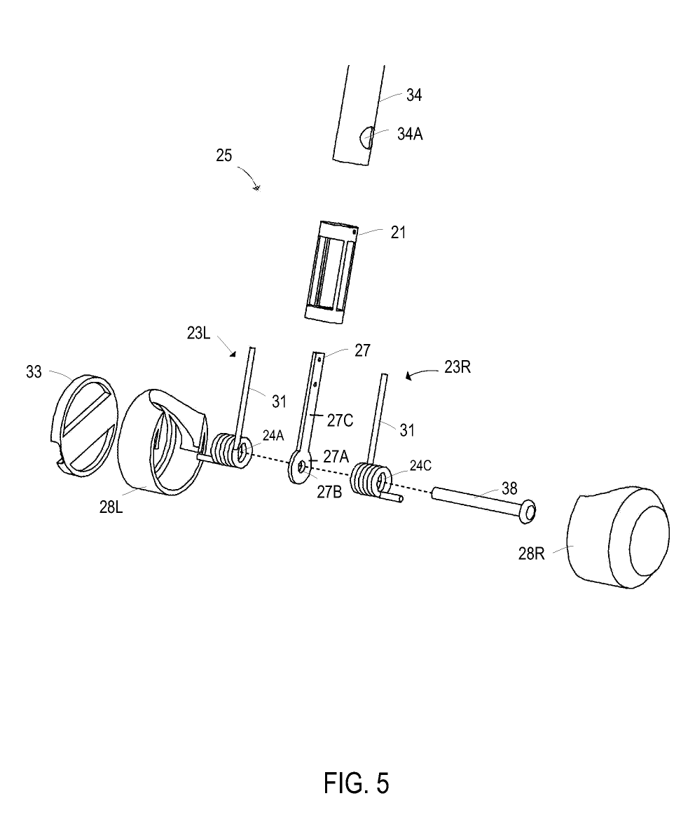

FIG. 5 illustrates an exploded view of a tension device 25 for each of the handles 5, according to an embodiment of the present invention. The tension device 25 includes a left-wound torsion spring 23L and a right-wound torsion spring 23R, each having a deflection angle of about 90 degrees, as shown. Disposed between the pair of torsion springs 23L, 23R is a separator 27 with an annular portion 27A having about the same outside diameter of coil portion 24A of the torsion spring 23L and coil portion 25C of the torsion spring 23R, and a circular opening 24B having a diameter about the same or less than the inside diameter of the coil portions 24A, 24C. To hold the assembly in place, a sleeve 21 is fitted around end portions 31 of the torsion spring 23L, 23R and an elongated portion 27C of the separator 27. The sleeve 21 is then fitted into a lower handle portion 34. An elongated cylindrical fastener 38 (e.g., an unthreaded bolt) having a diameter about the same or slightly less than the inside diameter of the coil portions 24A, 24C and the circular opening 24B is disposed through a first lower handle portion opening 34A (wherein the head of the fastener 38 is wider than the diameter of the first lower handle portion opening 34A), the coil portions 24A, 24C and the circular opening 24B. A pair of caps 28L, 28R are then attached to left and right sides, respectively, of the tension device 25. An end cap 33 is fitted into the cap 28L. It is to be understood that the embodiment of the tension device 25 described herein is meant for illustrative purposes, and is not meant to be limiting.

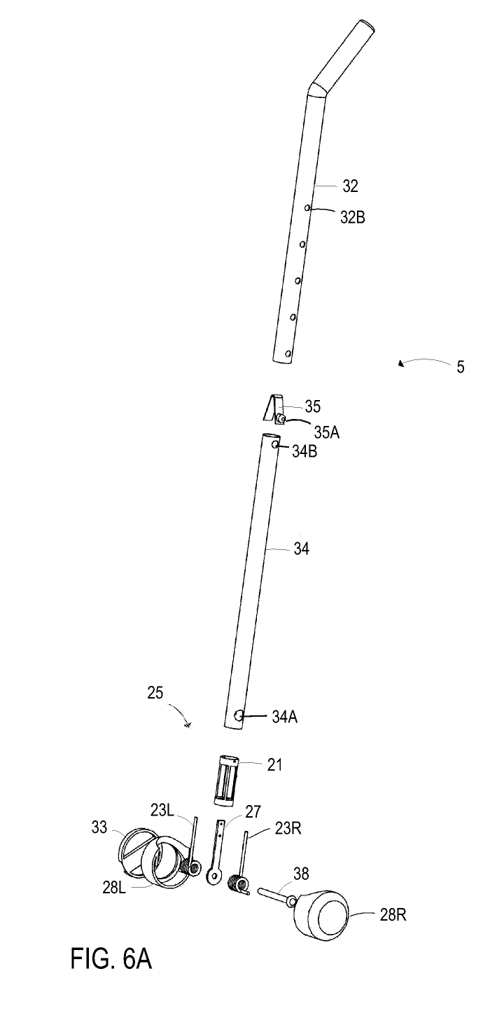

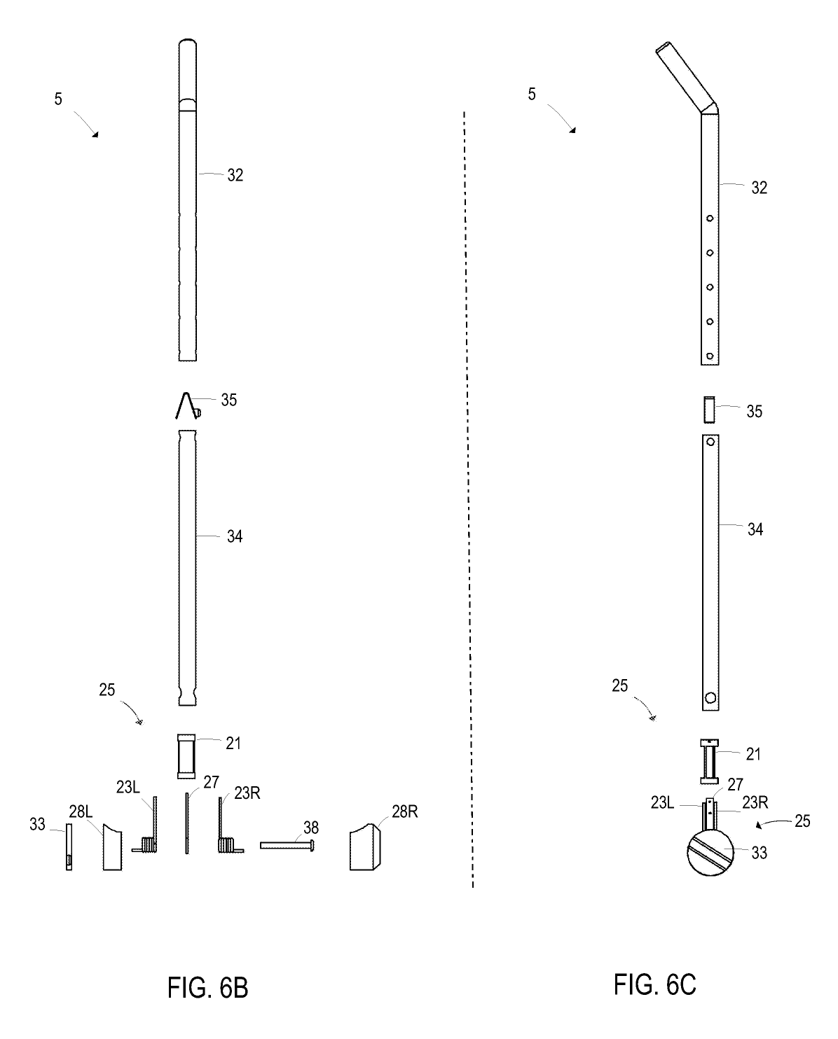

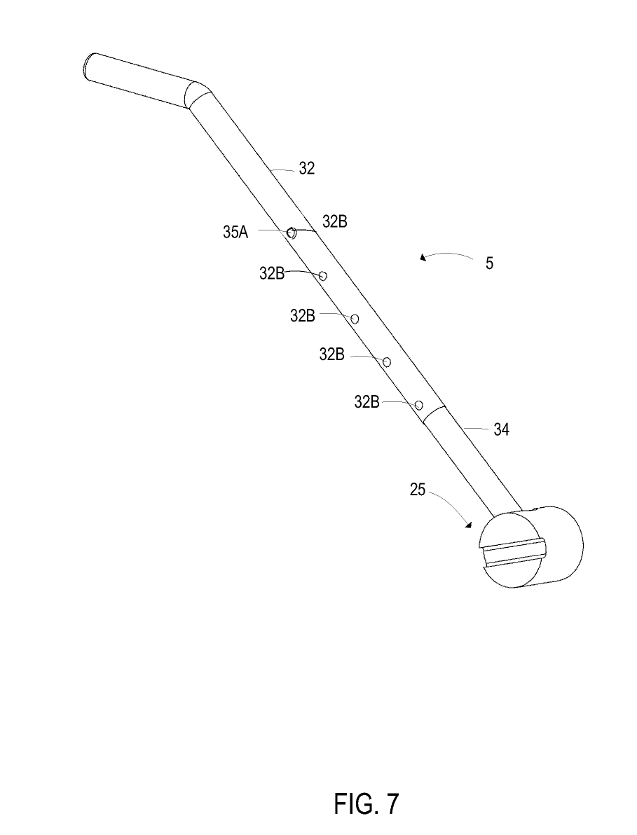

FIGS. 6A-6C illustrate various views of the tension device 25 along with parts of the handle 5. As shown, the handle 5 includes an upper handle portion 32, the lower handle portion 34, and a handle fastener 35. The upper handle portion 32 has an inside diameter larger than the outside diameter of the lower handle portion, and thus the lower handle portion handle portion 24 can be inserted into the upper handle portion 32. The handle fastener 35 includes a button 35A. When the handle 5 is assembled, the handle fastener 35 is placed inside the handle 5 such that the button 35A extends through a second lower handle portion opening 34B and one of a plurality of upper handle portion openings 32B. The length of the handle depends on which one of the upper handle portion openings 32B is selected, allowing the user to adjust the length of the handle 5 accordingly.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. An exercise stroller, comprising:
a stroller frame;
a seat attached to the stroller frame;
at least three wheels, each attached to the stroller frame by a respective leg; and
a pair of handles, each handle pivotally attached to the stroller frame and capable of being moved in a forward and backward direction.

2. The exercise stroller of claim 1, wherein each of the handles further includes a tension device to provide resistance to the movement of the handles.

3. The exercise stroller of claim 2, wherein the tension device includes a pair of torsion springs.

4. The exercise stroller of claim 3, wherein one of the torsion springs is left wound and the other of the torsion springs is right wound.

5. The exercise stroller of claim 3, wherein the pair of torsion spring is included in an enclosure, one the torsion springs disposed on a left side of the enclosure and the other torsion spring disposed on a right side of the enclosure.

6. The exercise stroller of claim 5, further comprising a fastener extending through the enclosure securing the pair of torsion springs to the handle.

7. The exercise stroller of claim 5, wherein the enclosure includes at least one cap.

8. The exercise stroller of claim 1, wherein the stroller frame is foldable.

9. The exercise stroller of claim 1, wherein a cover is attached to the stroller frame capable of providing shade for child sitting in the seat.

10. An exercise stroller, comprising:
a stroller frame;
a seat attached to the stroller frame;
a plurality of wheels, each attached to the stroller frame; and
a pair of handles, each handle pivotally attached to the stroller frame and including a pair of torsion springs, one of the torsion springs left wound and the other of the torsion springs right wound, the handles capable of being operated in an alternating fashion while the stroller is pushed forward.

11. The exercise stroller of claim 10, wherein the pair of torsion spring is included in an enclosure, wherein one of the torsion springs is disposed on a left side of the enclosure and the other torsion spring is disposed on a right side of the enclosure.

12. The exercise stroller of claim 11, further comprising a fastener securing the pair of torsion springs to the handle.

13. The exercise stroller of claim 11, wherein the enclosure includes at least one cap.

14. The exercise stroller of claim 10, wherein the stroller frame is foldable.

15. The exercise stroller of claim 10, wherein a cover is attached to the stroller frame capable of providing shade for child sitting in the seat.

16. The exercise stroller of claim 10, wherein one of the torsion springs is left wound and the other of the torsion springs is right wound.

17. An exercise stroller, comprising:
means for supporting the stroller;
means for seating;
means for facilitating transportation of the stroller; and
means for providing alternating handle movement of the stroller.
